(19) United States
(12) Patent Application Publication
(10) Pub. No.: US 2021/0324213 A1
(43) Pub. Date: Oct. 21, 2021

(54) POLYURETHANE BLOCK COPOLYMER INK COMPOSITIONS AND METHODS FOR USE AND MAKING THEREOF

(71) Applicant: BASF SE, Ludwigshafen am Rhein (DE)

(72) Inventors: Alexis A. BLEVINS, Southfield, MI (US); David Zachary AGER, Wyandotte, MI (US)

(21) Appl. No.: 17/272,374

(22) PCT Filed: Aug. 2, 2019
(86) PCT No.: PCT/EP2019/070849

§ 371 Date: Mar. 1, 2021

Related U.S. Application Data
(60) Provisional application No. 62/725,588, filed on Aug. 31, 2018.

(51) Int. Cl. C09D 11/102; B65D 65/42; B65D 65/40; B32B 27/08

(52) U.S. Cl. CPC C09D 11/102; B65D 65/42; C08G 18/755; B32B 27/08; B65D 65/40

(57) ABSTRACT

A method of preparing a printed article includes: applying an ink to a substrate and overlaying a substantially transparent lamination layer over the ink to envelope at least a portion of the substrate. The ink includes a polyurethane copolymer-based binder, wherein the polyurethane copolymer includes a block copolymer comprising the reaction product of a diisocyanate, a first polyol compound, a second polyol compound different from the first polyol compound, and a chain extending agent.

### FIELD

The present technology is generally related to methods of preparing a printed article that includes applying an ink to a substrate and overlaying a substantially transparent lamination layer over the ink to envelope at least a portion of the substrate. The ink includes a polyurethane copolymer with at least two different polyol compounds incorporated therein in a stepwise manner to produce a block copolymer. The printed article may be a retort packaging such as a pouch and/or a laminate.

### BACKGROUND

Retort packaging is a type of packaging that is constructed from a laminate of flexible plastic and metal foils. It is used for the sterile packaging of a wide variety of food or drink items as well as medical apparatuses.

In a solvent-based film to film lamination system, graphics are typically reverse-printed onto one of the films and then are joined to another film using an adhesive. A typical structure often consists of a top film and a bottom film between which are sandwiched a color ink layer, a white ink layer, and an adhesive layer, usually having this order from top to bottom. Graphics are usually printed onto the top film and the bottom film often acts as a sealant. Typical films utilized are polyethylene terephthalate (PET), oriented polypropylene (OPP), oriented polyamide (OPA), or polyethylene (PE) but are not limited to only those as many others such as metallic films can also be used. The adhesives employed are typically two-part 100% solids systems or solvent-borne polyurethane adhesives.

Printed graphics in the retort system typically represent a weak point in the laminate in terms of lamination bond strength as measured by a peel test. The inks used in these types of systems are typically polyurethane binders combined with pigment dispersions prepared in either a polyurethane resin or nitro cellulose. For high performance applications, the ink must maintain high lamination bond strengths after retort conditions. Retort conditions are typically 131° C. for 40 minutes which allows food inside of packaging to either be cooked or the package to be sterilized.

### SUMMARY

In one aspect, a process is provided for preparing a printed article. The process includes applying an ink to a substrate and overlaying a substantially transparent lamination layer over the ink to envelope at least a portion of the substrate. The ink includes a polyurethane copolymer-based binder (also referred to as polyurethane copolymer herein). Typically, the polyurethane copolymer is essentially free of carboxylic groups or salts thereof.

The polyurethane copolymer includes a block copolymer comprising the reaction product of a diisocyanate, a first polyol compound, a second polyol compound different from the first polyol compound, and a chain extending agent.

In one embodiment, the first polyol compound may be a polyether polyol; and the second polyol compound may be selected from the group consisting of polyester polyols, polycarbonate polyols, polyether carbonate polyols, polybutadiene polyols, polycaprolactone polyols, polyether polyols, and combinations of two or more thereof. In some embodiments, the polyurethane copolymer may have a weight average molecular weight of about 2,000 g/mol to about 100,000 g/mol.

In another embodiment, the first polyol compound may be selected from the group consisting of polyester polyols, polycarbonate polyols, polyether carbonate polyols, polybutadiene polyols, polycaprolactone polyols, polyether polyols, and combinations of two or more thereof; and the second polyol compound may be selected from the group consisting of polyester polyols, polycarbonate polyols, polyether carbonate polyols, polybutadiene polyols, polycaprolactone polyols, polyether polyols, and combinations of two or more thereof. In some embodiments, the polyurethane copolymer may have a weight average molecular weight of about 2,000 g/mol to about 100,000 g/mol.

The polyurethane copolymer may be prepared Method 1 or Method 2.

Method 1 includes: i) reacting a diisocyanate with a first polyol compound to produce a first polyurethane prepolymer comprising at least one isocyanate group, wherein the first polyol compound is a polyether polyol; ii) reacting the first polyurethane prepolymer of step i) with a second polyol compound different from the first polyol compound of step i) to produce a second polyurethane prepolymer comprising at least one isocyanate group, wherein the second polyol compound is selected from the group consisting of polyester polyols, polycarbonate polyols, polyether carbonate polyols, polybutadiene polyols, polycaprolactone polyols, polyether polyols, and combinations of two or more thereof; and iii) reacting the second polyurethane prepolymer of step ii) with a chain extending agent. In some embodiments, the process for preparing the polyurethane copolymer may further include isolating the polyurethane copolymer.

Method 2 includes: i) reacting a diisocyanate with a first polyol compound to produce a first polyurethane prepolymer comprising at least one isocyanate group, wherein the first polyol compound is selected from the group consisting of polyester polyols, polycarbonate polyols, polyether carbonate polyols, polybutadiene polyols, polycaprolactone polyols, polyether polyols, and combinations of two or more thereof; ii) reacting a diisocyanate with a second polyol compound different from the first polyol compound of step i) to produce a second polyurethane prepolymer comprising at least one isocyanate group, wherein the second polyol compound is selected from the group consisting of polyester polyols, polycarbonate polyols, polyether carbonate polyols, polybutadiene polyols, polycaprolactone polyols, polyether polyols, and combinations of two or more thereof; iii) reacting the first polyurethane prepolymer of step i) with a chain extending agent to produce a third polyurethane prepolymer comprising at last one amino group; and iv) reacting the third polyurethane prepolymer of step iii) with the second polyurethane prepolymer of step ii). In some embodiments, the process for preparing the polyurethane copolymer may further include isolating the polyurethane copolymer.

In another aspect, a method is provided for preparing a retort packaging article. The method includes applying an ink to an inner surface of a substantially transparent lamination layer in a reverse printing orientation to form a printed laminate and applying the printed laminate to and enveloping at least a portion of a sealable packaging. The ink includes a polyurethane copolymer-based binder as provided herein.

In another aspect, provided herein is a printing ink composition that includes a solvent and a polyurethane copolymer-based binder as provided herein. In some embodiments, the printing ink composition may further include a colorant.

In another aspect, a retort packaging is provided that includes a sealable foil-based packaging substrate having an inner and outer surface; a laminate overlay having an inner face and an outer face, the inner face being proximal to the sealable foil-based packaging substrate; and an indicia disposed between the sealable foil-based packaging substrate and the laminate overlay. The indicia includes a polyurethane copolymer-based binder as provided herein. The retort packaging may exhibit a peel strength of the laminate overlay from the foil-based packaging substrate of greater than 150 g/inch.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As used herein, the number average molecular weight (Mₙ) is the statistical average molecular weight of all the polymer chains in the polymer and is defined by:

Mₙ=(ΣNᵢMᵢ)/ΣNᵢ,

where Mᵢ is the molecular weight of a chain, and Nᵢ is the number of chains of that molecular weight.

As used herein, the weight average molecular weight (M_{w}) is defined as:

M_{w}=(ΣNᵢMᵢ²)/ΣNᵢ.

Compared to Mₙ, M_{w} takes into account the molecular weight of a chain in determining contributions to the molecular weight average. The more massive the chain, the more the chain contributes to M_{w}.

As used herein, the average molecular weight (M_{z}) can be defined by the equation:

M_{z}=(ΣNᵢMᵢ³)/ΣNᵢ.

“Polydispersity ratio” or “polydispersity index” is a measure of the distribution of molecular mass in a given polymer sample. PDI of a polymer is calculated: PDI=M_{w}/Mₙ. Polymers or oligomers having the same average molecular weight, but having a different molecular polydispersity possess different solution viscosities. The product with the higher polydispersity has a higher solution viscosity, because high molecular weight fractions make a significantly greater contribution toward viscosity than low molecular weight fractions.

“Glass transition temperature” or “T_{g}” refers to a material's range of temperatures over which a glass transition occurs.

In general, “substituted” refers to an alkyl or cycloalkyl group, as defined below (e.g., an alkyl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including single, double or triple bonds, to a heteroatom. A substituted group may be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyl, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like.

As used herein, “alkyl” groups include straight chain and branched alkyl groups having from 1 to about 30 carbon atoms, and typically from 1 to 24 carbons or, in some embodiments, from 1 to 18 carbon atoms including 1 to about 12 and 1 to about 8. As employed herein, “alkyl groups” include cycloalkyl groups as defined below. Alkyl groups may be substituted or unsubstituted. Examples of straight chain alkyl groups include methyl, ethyl, n-propyl, n-butyl, n-pentyl, n-hexyl, n-heptyl, and n-octyl groups. Examples of branched alkyl groups include, but are not limited to, isopropyl, sec-butyl, t-butyl, neopentyl, and isopentyl groups. Alkyl groups may be unsubstituted or substituted one or more times with various substituents such as those listed above.

Cycloalkyl groups are cyclic alkyl groups such as, but not limited to, cyclopropyl, cyclobutyl, cyclopentyl, cyclohexyl, cycloheptyl, and cyclooctyl groups. In some embodiments, the cycloalkyl group has 3 to 13 ring members, whereas in other embodiments the number of ring carbon atoms range from 5 to 8, 9, 10, 11, or 12 or 3 to 5, 6, or 7. Cycloalkyl groups may be substituted or unsubstituted. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined above including alkyl substituted cycloalkyl (i.e. alkylcycloalkyl such as C₄-C₁₅ alkylcycloalkyl or C₆-C₁₂ alkylcycloalkyl). Cycloalkyl groups also include rings that are substituted with alkylcycloalkyl groups (i.e., cycloalkyl-alkyl-cycloalkyl such as C₁₀-C₂₀ cycloalkyl-alkyl-cycloalkyl or C₁₂-C₁₅ cycloalkyl-alkyl-cycloalkyl). Cycloalkyl groups may be unsubstituted or substituted one or more times with various substituents such as those listed above.

As used herein, “essentially free” refers to less than about 1%, less than about 0.5%, less than about 0.1%, or less than about 0.05%. For example, the polyurethane copolymer maybe essentially free of carboxylic groups or salts thereof, wherein the percent is wt % (M_{w}, Mₙ, and/or M_{z}) based on the total weight of the polyurethane copolymer. In some embodiments, the polyurethane copolymer may include 0 wt % carboxylic groups based on the total weight of the polyurethane copolymer.

As set forth herein, it has surprisingly been discovered that block polyurethane copolymers used as a binder in an ink for printing in lamination systems can improve bond strength of the ink over standard polyurethane polymers. Additionally, block polyurethane copolymers can be adjusted to tune polarity, aromaticity, and functionality to achieve performance not available by known polyurethane polymers. The use of block polyurethane copolymers may also allow for cost reduction of new elastomers that perform at current technology levels.

Prior to the present technology, it was not possible to mix two dissimilar polyols, because prior to completion of the desired reaction the polyols would separate. Known methods for producing polyurethane polymers for ink application consist of two steps: (1) preparing a polyurethane prepolymer by reacting a polyol component and an isocyanate component (in excess) and (2) reacting the polyurethane prepolymer with a chain extending agent, and if necessary with a reaction terminating agent.

In contrast to known methods, the present technology provides a process for including two dissimilar polyol compounds within the same polyurethane copolymer-based binder to form a block polyurethane copolymer as described herein. The polyurethane copolymer may be prepared using step-wise Method 1 or Method 2. The polyurethane copolymer commonly is essentially free of carboxylic groups or salts thereof.

Method 1 for preparing the polyurethane copolymer includes: i) reacting the diisocyanate with the first polyol compound to produce a first polyurethane prepolymer comprising at least one isocyanate group; ii) reacting the first polyurethane prepolymer of step i) with the second polyol compound to produce a second polyurethane prepolymer comprising at least one isocyanate group; and iii) reacting the second polyurethane prepolymer of step ii) with a chain extending agent. The first polyol compound is a polyether polyol; the second polyol compound is selected from the group consisting of polyester polyols, polycarbonate polyols, polyether carbonate polyols, polybutadiene polyols, polycaprolactone polyols, polyether polyols, and combinations of two or more thereof.

In some embodiments, the first polyol compound may be reacted with the diisocyanate at a temperature between about 20° C. to about 120° C. to obtain a first polyurethane prepolymer having a predetermined isocyanate content (NCO %) measured according to a method based on JIS-K1556. Subsequently, a second polyol compound is added into the reactor to react with the first polyurethane prepolymer, and the reaction is continued under a temperature condition within a range of about 20° C. to about 120° C. until a second polyurethane prepolymer having a predetermined isocyanate content is obtained. The second polyurethane prepolymer may then be reacted with a chain extending agent to obtain the polyurethane copolymer.

Method 2 for preparing the polyurethane copolymer includes: i) reacting the diisocyanate with the first polyol compound to produce a first polyurethane prepolymer comprising at least one isocyanate group, ii) reacting the diisocyanate with the second polyol compound to produce a second polyurethane prepolymer comprising at least one isocyanate group, iii) reacting the first polyurethane prepolymer of step i) with the chain extending agent to produce a third polyurethane prepolymer comprising at last one amino group; and iv) reacting the third polyurethane prepolymer of step iii) with the second polyurethane prepolymer of step ii). The first polyol compound is selected from the group consisting of polyester polyols, polycarbonate polyols, polyether carbonate polyols, polybutadiene polyols, polycaprolactone polyols, polyether polyols, and combinations of two or more thereof; the second polyol compound is selected from the group consisting of polyester polyols, polycarbonate polyols, polyether carbonate polyols, polybutadiene polyols, polycaprolactone polyols, polyether polyols, and combinations of two or more thereof.

In some embodiments, the first polyol compound may be reacted with the diisocyanate at a temperature between about 20° C. to about 120° C. to obtain a first polyurethane prepolymer having a predetermined isocyanate content. The first polyol compound may then be reacted with a chain extending agent to obtain a third polyurethane prepolymer. Similarly, the second polyol compound may be reacted with the diisocyanate at a temperature between about 20° C. to about 120° C. to obtain a second polyurethane prepolymer having a predetermined isocyanate content. The third polyurethane prepolymer and the second polyurethane prepolymer may then be reacted at a temperature between about 20° C. to about 100° C. to obtain the polyurethane copolymer.

In some embodiments, chain extension reaction can be carried out by adding dropwise the previously prepared polyurethane prepolymer to a mixture containing a chain extending agent as described herein, an organic solvent (as described herein) and if necessary, a reaction terminating agent, under a temperature condition within a range of about 30° C. to about 120° C. For method 1, the polyurethane copolymer may be obtained by continuing the chain extension reaction until the remaining isocyanate groups all disappear.

In some embodiments, the process(es) for preparing the polyurethane copolymer may further include reacting the polyurethane copolymer with a terminating agent and/or isolating the polyurethane copolymer. Terminating agents include dialkylamines such as dimethylamine, diethylamine, and/or dibutylamine. When the reaction terminating agent is used in addition to the chain extending agent, regulation of the molecular weight is made possible, and the terminal chemical structure of the polyurethane copolymer can be controlled.

In some embodiments, solvents and/or catalysts may also be used if necessary in one or more of the series of reactions for producing the polyurethane copolymers. The catalysts may be any known compounds that are conventionally used in the urethanization of polyurethane resins. Nonlimiting examples include stannous octanoate, dibutyltin acetate, dibutyltindilaurate, and tetrabutoxytitanate.

In one aspect, a printing ink composition and a process for preparing a printing ink composition are provided. The ink of the present technology includes a polyurethane copolymer-based binder as described herein and typically a solvent. The polyurethane copolymer is prepared by method 1 or method 2 as described herein. The ink desirably has excellent printability including fluidity, adhesiveness and anti-blocking properties.

Solvents for producing the polyurethane copolymers or for use in the printing ink composition may be any known organic solvents that are conventionally used as solvents for printing ink. For example, in the inks for flexographic printing, alcohol-based solvents such as methanol, ethanol, isopropanol, n-propanol, isobutanol, and/or n-butanol; ester-based solvents such as methyl acetate, ethyl acetate, isopropyl acetate, n-propyl acetate, n-butyl acetate, t-butyl acetate, and/or isobutyl acetate; cycloalkyl and aromatic solvents such as toluene, xylene, cyclohexane, n-hexane, and/or cyclohexane; n-hexane; polyhydric alcohol derivatives such as ethylene glycol monomethyl ether, ethylene glycol monoethyl ether, ethylene glycol monobutyl ether, propylene glycol monomethyl ether, propylene glycol monoethyl ether, diethylene glycol monomethyl ether, and/or diethylene glycol monobutyl; and combinations oftwo or more thereof. Concerning ethanol, synthetic ethanol and fermented ethanol, which is known as so-called bio-ethanol, can all be used. According to an embodiment of the present technology, it is preferable to use such a solvent at the time of preparation of the polyurethane copolymer from the viewpoint of carrying out the reaction uniformly.

The ink composition may be prepared by dissolving and/or dispersing the polyurethane copolymer-based binder and a colorant, as well as various additives/components that are used according to necessity, in an organic solvent as described herein. In some embodiments, the ink composition may be prepared by using (or preparing in advance) a colorant dispersion in which a colorant and the polyurethane copolymer-based binder have been dispersed in an organic solvent as described herein, and incorporating other optional components to the resulting colorant dispersion.

To prepare the ink composition, a known colorant dispersing machine conventionally used in the art may be used. For example, a roller mill, a ball mill, a pebble mill, an attritor, or a sand mill can be used as the dispersing machine. The particle size distribution of the colorant (e.g., pigment) in the colorant dispersion can be regulated by appropriately adjusting the size of the pulverizing medium of the dispersing machine, filling ratio of the pulverizing medium, duration of the dispersing treatment, ejection speed of the pigment dispersion, viscosity of the pigment dispersion, and the like. During the preparation of the ink composition, various additives such as a colorant dispersant may be incorporated to improve fluidity and dispersibility of the ink. Furthermore, if air bubbles or unexpected coarse particles and the like are present in the resulting ink, they may be eliminated by filtering or other methods, so as to prevent deterioration of the quality of printed matters. For the filtering device, those conventionally known can be used.

The ink composition prepared according to the method described above may have a viscosity of about 10 mPas to about 1000 mPas. When the viscosity is adjusted to 10 mPas or higher, sedimentation of the colorant is prevented, and it is feasible to maintain adequate dispersibility. When the viscosity is adjusted to 1000 mPas or lower, the workability efficiency at the time of ink preparation or printing can be increased. Viscosity is a value obtained by making a measurement at 25° C. with a B-type viscometer manufactured by Tokimec, Inc. The viscosity of the ink can be regulated by appropriately selecting the various components used as raw materials, for example, the polyurethane resin, colorant, organic solvent and the like, and appropriately adjusting the respective mixing amounts. The viscosity of the ink can also be regulated by adjusting the particle size and particle size distribution of the colorant (e.g., pigment) in the ink.

The present technology also provides a surface coating or overprint varnish that includes the polyurethane copolymer described herein or the ink composition described herein.

In another aspect, printed articles and retort packaging articles (and methods for producing the articles) are provided. The articles exhibit a lamination bond strength of greater than 150 g/inch.

In one aspect, a process is provided for preparing a printed article. The process includes applying any of the inks described herein to a substrate and overlaying a substantially transparent lamination layer over the ink to envelope at least a portion of the substrate. The ink includes a polyurethane copolymer as described herein. The polyurethane copolymer is prepared by method 1 or method 2 as described herein.

In another aspect, provided herein is a printed article which includes a substrate; a substantially transparent laminate overlay having an inner face and an outer face, the inner face being proximal to the substrate; and any of the inks described herein between the substrate and the laminate overlay. The ink includes a polyurethane copolymer as described herein. The polyurethane copolymer is prepared by method 1 or method 2 as described herein.

In another aspect, a method is provided for preparing a retort packaging article. The method includes applying any of the described herein to an inner surface of a substantially transparent lamination layer in a reverse printing orientation to form a printed laminate and applying the printed laminate to and enveloping at least a portion of a sealable packaging. As noted above, the ink(s) includes a polyurethane copolymer-based binder as described herein. The polyurethane copolymer is prepared by method 1 or method 2 as described herein.

In another aspect, provided herein is a retort packaging article which includes a sealable foil-based packaging substrate having an inner and outer surface; a laminate overlay having an inner face and an outer face, the inner face being proximal to the sealable foil-based packaging substrate; and an indicia between the sealable foil-based packaging substrate and the laminate overlay. The indicia includes a polyurethane copolymer as described herein. The polyurethane copolymer is prepared by method 1 or method 2 as described herein. Additionally, the retort packaging article is subjected to a temperature of 100° C. or greater for a time period sufficient to cure the ink.

In another aspect, provided herein is a method for curing an indicia for a retort packaging article. The method includes providing a retort packaging article and heating the retort packaging article to a temperature and for a time period sufficient to cure an ink disposed on the retort packaging article. The retort packaging article includes a first substrate in the form of a sealable packaging, a substantially transparent lamination layer overlaying at least a portion of the sealable packaging, and any of the inks described herein containing the polyurethane copolymer described herein disposed between the substantially transparent lamination layer and the sealable packaging. The polyurethane copolymer is as described herein. The polyurethane copolymer is prepared by method 1 or method 2 as described herein.

In some embodiments, the retort packaging article is a laminate. In some embodiments, the retort packaging article is a pouch.

In some embodiments, the first and/or second polyol compound(s) may include a polyether polyol compound (e.g., polyether diol). Polyether polyol compounds may have a Mₙ of about 200 to about 5000 including about 500 to about 5000, about 1000 to about 5000, or about 2000 about 5000. In some embodiments, the polyether polyol may include a mixture of a polyether polyol and a polyester polyol (as described below). In some embodiments, the polyether polyol and polyester polyol may be mixed in a ratio of 100/0 to 20/80, based on the total weights of the components including 100/0 to 50/50. In some embodiments, when the mixing ratio of the polyester diol is adjusted to 80% or less, the solubility of the obtainable polyurethane copolymer in an alcohol solvent becomes satisfactory, and the fluidity or gloss of the printing ink tends to be enhanced. Non-limiting examples include polyoxytetramethylene glycol or polytetrahydrofuran, polyethylene glycol and polypropylene glycol.

In some embodiments, the first and/or second polyol compound(s) may be include a polyester polyol compound (e.g., polyether diol). The polyester polyol may be obtained by a condensation reaction between a dicarboxylic acid and polyol (e.g., diol). Nonlimiting examples of the dicarboxylic acid include aliphatic dicarboxylic acids such as adipic acid, sebacic acid, succinic acid, glutaric acid, maleic acid and fumaric acid, or anhydrides thereof; and aromatic carboxylic acids such as phthalic acid, isophthalic acid and terephthalic acid, or anhydrides thereof. Nonlimiting examples of the polyol include ethylene glycol, propylene glycol, 1,2-butylene glycol, 1,3-butylene glycol, 1,4-butanediol, 2,3-butylene glycol, isobutylene glycol, neopentyl glycol, 2-methyl-2-propyl-1,3-propanediol, 1,5-pentanediol, 1,6-hexanediol, 2-methyl-2,4-pentanediol, 3-methyl-1,5-pentanediol, 2,2,4-trimethyl-1,3-pentanediol, 2-ethyl-1,3-hexanediol, 2,5-methyl-2,5-hexanediol, 1,4-cyclohexanedimethanol, 1,4-butynediol, 1,4-butenediol, 2,5-dimethyl-3-hexyne-2,5-diol; and diols having a carboxyl group, such as dimethylolpropionic acid, dimethylolbutanoic acid, dimethylolbutanoic acid, dimethylolpentanoic acid, dimethylolbutyric acid and dimethylolvaleric acid. The polyester polyol can also be obtained by reacting a lactone compound such as s-caprolactone or β-methyl-.delta.-valerolactone with a polyol (e.g., diol monomer), a polyester polyol or a polyether, under a temperature condition of about 150-250° C. In some embodiments, the polyester polyol may have a Mₙ of about 500 or more or 1,000 or more. For example, the polyester polyol may have a Mₙ of about 500 to about 5,000 including about 1,000 to about 5,000 and about 2,000 to about 5,000.

Various types of known diisocyanates, including aromatic, aliphatic and alicyclic diisocyanates, may be used as the diisocyanate compound in the present technology. Nonlimiting examples include 1,5-naphthylene diisocyanate, 4,4′-diphenylmethane diisocyanate, 4,4′-diphenyldimethylmethane diisocyanate, 4,4′-dibenzyl isocyanate, dialkyldiphenylmethane diisocyanate, tetraalkyldiphenylmethane diisocyanate, 1,3-phenylene diisocyanate, 1,4-phenylene diisocyanate, tolylene diisocyanate, butane-1,4-diisocyanate, hexamethylene diisocyanate, isopropylene diisocyanate, methylene diisocyanate, 2,2,4-trimethylhexamethylene diisocyanate, 2,4,4-trimethylhexamethylene diisocyanate, cyclohexane-1,4-diisocyanate, xylene diisocyanate, isophorone diisocyanate, lysine diisocyanate, dicyclohexylmethane-4,4′-diisocyanate, 1,3-bis(isocyanatomethyl)cyclohexane, methylcyclohexane diisocyanate, tetramethylxylene diisocyanate, and combination of two or more thereof. In addition, a dimer diisocyanate obtained as a result of substituting the carboxyl group of a dimer acid with an isocyanate group, may also be used. In some embodiments, the diisocyanate may include isophorone diisocyanate.

In some embodiments, the chain extending agent may having two or more of a functional group that are capable of reacting with an isocyanate group in a molecule, which is well known in the related art. In some embodiments, the chain extending agent may include C₁-C₁₂ alkyl, C₃-C₁₃ cycloalkyl, C₁₀-C₂₀ cycloalkyl-alkyl-cycloalkyl, or C₄-C₁₅ alkylcycloalkyl. In some embodiments, the chain extending agent may include two more amino groups. For example, the amine may be a diamine, triamine, or tetramine. Nonlimiting examples include ethylenediamine, propylenediamine, hexamethylenediamine, triethylenetetramine, diethylenetriamine, isophoronediamine, or dicyclohexylmethane-4,4′-diamine. In some embodiments, the chain extending agent may be an alcohol comprising two more hydroxyl groups. For example, the alcohol may be a diol, triol, or tetraol. In some embodiments, the chain extending agent may include at least one amino group and at least one hydroxyl group. A nonlimiting example includes aminoethylethanolamine. In addition, a dimer diamine obtained as a result of substituting the carboxyl group or a dimer acid with an amino group and the like may also be used. In some embodiments, the chain extending agent is selected from the group consisting of ethylenediamine, propylenediamine, hexamethylenediamine, triethylenetetramine, diethylenetriamine, isophoronediamine, dicyclohexylmethane-4,4′-diamine, aminoethylethanolamine, and combinations of two or more thereof.

The polyurethane provided herein may exhibit a lamination bond strength of about 150 to about 700 Win. For example, the lamination bond strength may be about 150 g/in to about 400 g/in, about 170 to 450 g/in., about 180 to about 425 g/in., about 190 to 350 g/in. In some embodiments, the lamination bond strength may be about 200 to 300 g/in.

In some embodiments, the polyurethane copolymer may have a M_{w} of about 2,000 g/mol to about 100,000 g/mol. For example, the polyurethane copolymer may have a weight average molecular weight of about 5,000 g/mol to about 100,000 g/mol, about 6,000 g/mol to about 75,000 g/mol, about 8,000 g/mol to about 50,000 g/mol, or about 10,000 to about 20,000 g/mol.

In some embodiments, the ink may include less than about 50 wt % water. For example, the ink may include less than about 25 wt %, less than about 20 wt %, less than about 15 wt %, less than about 10 wt %, less than about 5 wt %, less than about 2 wt %, less than about 1 wt %, less than about 0.5 wt %, or less than about 0.1 wt % water.

In addition to the polyurethane copolymer provided herein, the ink may further include a colorant. In some embodiments, the colorant is an inorganic pigment, an organic pigment, a dye, or a mixture of any two or more such compounds. Non-limiting examples of pigments include bright pigments such as aluminum powder, copper powder, nickel powder, stainless steel powder, chromium powder, micaceous iron oxide, titanium dioxide-coated mica powder, iron oxide-coated mica powder, and bright graphite; organic red pigments such as Pink EB, azo- and quinacridone-derived pigments; organic blue pigments such as cyanin blue and cyanin green; organic yellow pigments such as benzimidazolone-, isoindolin- and quinophthalone-derived pigments; inorganic colored pigments such as titanium dioxide (white), titanium yellow, iron red, carbon black, chrome yellow, iron oxide and various calcined pigments. Additionally, extender pigments may be included. Other examples of suitable pigments include, but are not limited to, Raven 7000, Raven 5750, Raven 5250, Raven 5000 ULTRAII, Raven 3500, Raven 2000, Raven 1500, Raven 1250, Raven 1200, Raven 1190 ULTRAII, Raven 1170, Raven 1255, Raven 1080 and Raven 1060 (commercially available from Columbian Carbon Co.); Rega1400R, Rega1330R, Rega1660R, Mogul L, Black Pearls L, Monarch 700, Monarch 800, Monarch 880, Monarch 900, Monarch 1000, Monarch 1100, Monarch 1300 and Monarch 1400 (commercially available from Cabot Co.); Color Black FW1, Color Black FW2, Color Black FW2V, Color Black 18, Color Black FW200, Color Black S150, Color Black 5160, Color Black 5170, Printex35, PrintexU, PrintexV, Printex140U, Printex140V, Special Black 6, Special Black 5, Special Black 4A and Special Black 4 (commercially available from Degussa Co.); No. 25, No. 33, No. 40, No. 47, No. 52, No. 900, No. 2300, MCF-88, MA600, MA7, MA8 and MA100 (commercially available from Mitsubishi Chemical Corporation); cyanic color pigment like C.I. Pigment Blue-1, C.I. Pigment Blue-2, C.I. Pigment Blue-3, C.I. Pigment Blue-15, C.I. Pigment Blue-15:1, C.I. Pigment Blue-15:3, C.I. Pigment Blue-15:34, Pigment Blue 15:4; C.I. Pigment Blue-16, C.I. Pigment Blue-22 and C.I. Pigment Blue-60; magenta color pigment like C.I. Pigment Red-5, C.I. Pigment Red-7, C.I. Pigment Red-12, C.I. Pigment Red-48, C.I. Pigment Red-48:1, C.I. Pigment Red-57, Pigment Red-57:1, C.I. Pigment Red-112, C.I. Pigment Red-122, C.I. Pigment Red-123, C.I. Pigment Red-146, C.I. Pigment Red-168, C.I. Pigment Red-184 and C.I. Pigment Red-202; and yellow color pigment like C.I. Pigment Yellow-1, C.I. Pigment Yellow-2, C.I. Pigment Yellow-3, C.I. Pigment Yellow-12, C.I. Pigment Yellow-13, C.I. Pigment Yellow-14, C.I. Pigment Yellow-16, C.I. Pigment Yellow-17, C.I. Pigment Yellow-73, C.I. Pigment Yellow-74, C.I. Pigment Yellow-75, C.I. Pigment Yellow-83, C.I. Pigment Yellow-93, C.I. Pigment Yellow-95, C.I. Pigment Yellow-97, C.I. Pigment Yellow-98, C.I. Pigment Yellow-114, C.I. Pigment Yellow-128, C.I. Pigment Yellow-129, C.I. Pigment Yellow-151 and C.I. Pigment Yellow-154. Suitable pigments include a wide variety of carbon black, blue, red, yellow, green, violet, and orange pigments.

Non-limiting examples of dyes used in the inks disclosed herein include Solvent Red 24, Solvent Yellow 124, Solvent Blue 35, azobenzene based dyes, and antraquinone based dyes.

In some embodiments, the ink may include a pigment extender. Nonlimiting examples include carbonic acid salts such as calcium carbonate and magnesium carbonate; sulfuric acid salts such as sedimentary barium sulfate; and silicic acid salts such as silica, talc and mica, or combinations of two or more thereof.

In some embodiments, the ink may include a pigment extender. Nonlimiting examples include fillers that are well known in the related art to enhance the anti-blocking property of the ink composition and the laminate strength, and for this purpose, the extender pigments mentioned above may also be used.

The ink may also further include a defoamer to provide the desired foaming characteristics. Suitable defoaming agents include, but are not limited to, Foamaster® S (blend of silica and oil, including mineral oil produced by BASF), Rhodoline® DF 540 (produced by Rhodia), Rhodoline® 635 (produced by Solvay), Foamaster® MO 2170 (produced by BASF), and Foamaster® MO 2190 (produced by BASF).

The ink may also further include an adhesion promoter to improve the adhesion of the ink to the substrate. Suitable adhesion promoters include, but are not limited to, titanium chelates, organosilane, polyacrylic acid, and polymethlacrylic acid.

In some embodiments, the ink may further include at least one of a colorant, defoamer, or adhesion promoter. In some embodiments, the ink may further include at least two of a colorant, defoamer, or adhesion promoter.

In addition to the polyurethane copolymer provided herein, the indicia may further include a colorant. In some embodiments, the colorant is an inorganic pigment, an organic pigment, a dye, or a mixture of any two or more such compounds. Non-limiting examples of pigments include bright pigments such as aluminum powder, copper powder, nickel powder, stainless steel powder, chromium powder, micaceous iron oxide, titanium dioxide-coated mica powder, iron oxide-coated mica powder, and bright graphite; organic red pigments such as Pink EB, azo- and quinacridone-derived pigments; organic blue pigments such as cyanin blue and cyanin green; organic yellow pigments such as benzimidazolone-, isoindolin- and quinophthalone-derived pigments; inorganic colored pigments such as titanium dioxide (white), titanium yellow, iron red, carbon black, chrome yellow, iron oxide and various calcined pigments. Additionally, extender pigments may be included. Other examples of suitable pigments include, but are not limited to, Raven 7000, Raven 5750, Raven 5250, Raven 5000 ULTRAII, Raven 3500, Raven 2000, Raven 1500, Raven 1250, Raven 1200, Raven 1190 ULTRAII, Raven 1170, Raven 1255, Raven 1080 and Raven 1060 (commercially available from Columbian Carbon Co.); Rega1400R, Rega1330R, Rega1660R, Mogul L, Black Pearls L, Monarch 700, Monarch 800, Monarch 880, Monarch 900, Monarch 1000, Monarch 1100, Monarch 1300 and Monarch 1400 (commercially available from Cabot Co.); Color Black FW1, Color Black FW2, Color Black FW2V, Color Black 18, Color Black FW200, Color Black S150, Color Black S160, Color Black S170, Printex35, PrintexU, PrintexV, Printex140U, Printex140V, Special Black 6, Special Black 5, Special Black 4A and Special Black 4 (commercially available from Degussa Co.); No. 25, No. 33, No. 40, No. 47, No. 52, No. 900, No. 2300, MCF-88, MA600, MA7, MA8 and MA100 (commercially available from Mitsubishi Chemical Corporation); cyanic color pigment like C.I. Pigment Blue-1, C.I. Pigment Blue-2, C.I. Pigment Blue-3, C.I. Pigment Blue-15, C.I. Pigment Blue-15:1, C.I. Pigment Blue-15:3, C.I. Pigment Blue-15:34, Pigment Blue 15:4; C.I. Pigment Blue-16, C.I. Pigment Blue-22 and C.I. Pigment Blue-60; magenta color pigment like C.I. Pigment Red-5, C.I. Pigment Red-7, C.I. Pigment Red-12, C.I. Pigment Red-48, C.I. Pigment Red-48:1, C.I. Pigment Red-57, Pigment Red-57:1, C.I. Pigment Red-112, C.I. Pigment Red-122, C.I. Pigment Red-123, C.I. Pigment Red-146, C.I. Pigment Red-168, C.I. Pigment Red-184 and C.I. Pigment Red-202; and yellow color pigment like C.I. Pigment Yellow-1, C.I. Pigment Yellow-2, C.I. Pigment Yellow-3, C.I. Pigment Yellow-12, C.I. Pigment Yellow-13, C.I. Pigment Yellow-14, C.I. Pigment Yellow-16, C.I. Pigment Yellow-17, C.I. Pigment Yellow-73, C.I. Pigment Yellow-74, C.I. Pigment Yellow-75, C.I. Pigment Yellow-83, C.I. Pigment Yellow-93, C.I. Pigment Yellow-95, C.I. Pigment Yellow-97, C.I. Pigment Yellow-98, C.I. Pigment Yellow-114, C.I. Pigment Yellow-128, C.I. Pigment Yellow-129, C.I. Pigment Yellow-151 and C.I. Pigment Yellow-154. Suitable pigments include a wide variety of carbon black, blue, red, yellow, green, violet, and orange pigments.

The indicia may also further include a defoamer to provide the desired foaming characteristics. Suitable defoaming agents include, but are not limited to, Foamaster® S (blend of silica and oil, including mineral oil produced by BASF), Rhodoline® DF 540 (produced by Rhodia), Rhodoline® 635 (produced by Solvay), Foamaster® MO 2170 (produced by BASF), and Foamaster® MO 2190 (produced by BASF).

The indicia may also further include an adhesion promoter to improve the adhesion of the ink to the substrate. Suitable adhesion promoters include, but are not limited to, titanium chelates, organosilane, polyacrylic acid, and polymethlacrylic acid.

In some embodiments, the indicia may further include at least one of a colorant, defoamer, or adhesion promoter. In some embodiments, the ink may further include at least two of a colorant, defoamer, or adhesion promoter.

### EXAMPLES

GPC spectra were acquired with a Waters 2695 instrument and was used to determine molecular weight of polymers using THF as the mobile phase at 40° C. and a RI detector. All samples were analyzed for Mₙ, M_{w}, and PDI using elution times calibrated against polystyrene molecular weight standards.

### Example 1—Synthesis of Poly-co-Tetrahydrofuran (2000)-Block-co-Polyurethane Prepolymers

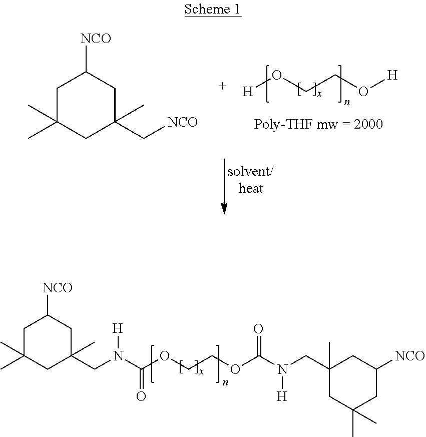

To a glass reactor, butyl acetate (Sigma-Aldrich, 110 grams, anhydrous) was added along with isophorone diisocyanate (IPDI, Sigma-Aldrich, 71.4 grams, 1.01 mole, 2.02 equivalents of NCO groups) and BiCAT 8 (Shepherd Chemical, 0.21 grams). The reactor was sealed and filled with nitrogen after which polytetrahydrofuran (BASF, 2000 molecular weight, 318.46 grams, 0.50 mole, 1.00 equivalent of hydroxyl groups) was charged into the reactor over 30 minutes at ambient temperature followed by heating to 78° C. and allowed to react for 90 minutes to make a poly-THF 2000 polyurethane block prepolymer. The product was cooled to ambient temperature and discharged into a clean dry bottle and sealed for storage until later use.

### Example 2—Synthesis of Poly-co-Tetrahydrofuran (650)-Block-co-Polyurethane Prepolymers

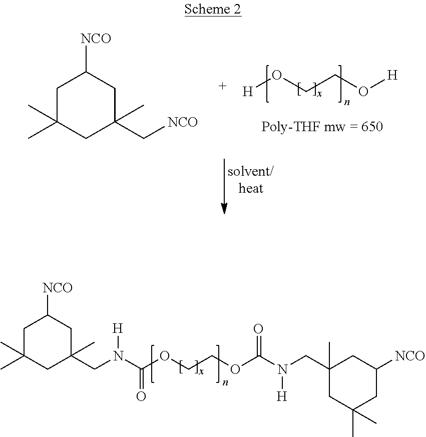

To a glass reactor, butyl acetate (Sigma-Aldrich, 88.3 grams, anhydrous) was added along with isophorone diisocyanate (IPDI, Sigma-Aldrich, 100.5 grams, 0.695 mole, 1.39 equivalent of NCO groups) and BiCAT 8 (Shepherd Chemical, 0.19 grams). The reactor was sealed and filled with nitrogen after which polytetrahydrofuran (BASF, 650 molecular weight, 211.4 grams, 0.50 mole, 1.0 equivalent of hydroxyl groups) was charged into the reactor over 30 minutes at ambient temperature followed by heating to 78° C. and allowed to react for 90 minutes to make a poly-THF 650 polyurethane block prepolymer. The product was cooled to ambient temperature and discharged into a clean dry bottle and sealed for storage until later use.

### Example 3—Synthesis of Poly-co-Tetrahydrofuran-Block-co-Polyurethane Copolymers (650/2000)

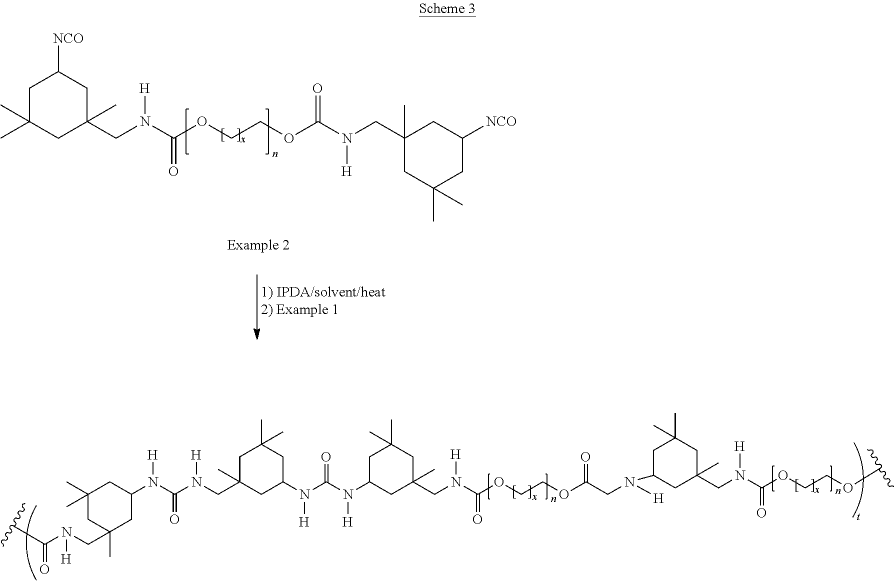

To a clean reactor, isopropanol (Sigma-Aldrich, 387 grams) was added to isophorone diamine (IPDA, Sigma-Aldrich, 22.3 grams, 0.13 moles) and butyl acetate (Sigma-Aldrich, 88.2 grams) after which the reactor was sealed. The mixture was heated to 35° C. and the prepolymer of Example 2 (264.6 grams) was charged into the reactor over 20 minutes under nitrogen.

The prepolymer of Example 1 (88.3 grams) was charged into the same reactor over 20 minutes under nitrogen. Once both prepolymers were added into the reactor, it was then allowed to react at 40° C. for 45 minutes to generate the final polyurethane copolymer. The resulting polyurethane copolymer solution was then allowed to cool before final evaluation. The final copolymer solution had a viscosity of 1640 centipoise (cP) with a net volume solids of 35.6 percent. The final copolymer had the following properties: Tg=−59.9° C., Mn=11,779 g/mole, Mw=31,253 g/mole, PDI=2.65.

The desired reaction with the diamine proceeds in the presence of alcohol due to the reaction rate of the amine is significantly greater at 30-35° C. than the reaction rate of the alcohol at that temperature. For appreciable reaction rates of alcohols with isocyanates, a temperature of 55-60° C. or greater is required.

### Example 4—Synthesis of Poly-co-Tetrahydrofuran-Block-co-Polyurethane Copolymers (2000/650)

To a clean reactor, isopropanol (Sigma-Aldrich, 387 grams) was added to isophorone diamine (IPDA, Sigma-Aldrich, 24.04 grams, 0.14 moles) and butyl acetate (Sigma-Aldrich, 88.7 grams) after which the reactor was sealed. The mixture was heated to 35° C. and the prepolymer of Example 1 (175.4 grams) was charged into the reactor over 20 minutes under nitrogen.

The prepolymer of Example 2 (175.4 grams) was charged into the same reactor over 20 minutes under nitrogen. Once both prepolymers were added into the reactor, it was then allowed to react at 40° C. for 45 minutes to generate the final copolymer. The resulting polyurethane copolymer solution was then allowed to cool before final evaluation. The final copolymer solution had a viscosity of 1460 centipoise (cP) with a net volume solids of 35.2 percent. The final copolymer had the following properties: Tg=−73° C., Mn=11,507 g/mole, Mw=26,710 g/mole, PDI=2.32

Based on the thermal data (T_{g}, glass transition temperature), a different polymer structure was obtained by changing the order of addition of the two different poly-co-tetrahydrofuran-co-polyurethane prepolymer segments.

### Example 5—Synthesis of Poly-co-Tetrahydrofuran-Block-co-Polyurethane Copolymers

Following the procedures above and in a step-wise fashion, polytetrahydrofuran (650 molecular weight) was reacted with isophorone diisocyanate. The resulting polyurethane prepolymer was then reacted with polypropylene glycol (2000 molecular weight). The resulting polyurethane di-block prepolymer was then reacted with polytetrahydrofuran (2000 molecular weight). The resulting polyurethane tri-block prepolymer was then reacted with isophorone diamine in a manner similar to Example 4. The final copolymer solution had a net volume solids of 34.7 percent. The final copolymer had the following properties: Tg=−68° C., Mn=12,000 g/mole, Mw=35,000 g/mole, PDI=3.0.

### Example 6—Synthesis of Poly-co-Tetrahydrofuran-Block-co-Polyurethane Copolymers

Similar to Example 4, a polyether polyol/polybutadiene polyol polyurethane block copolymer was synthesized having a Tg=−45.5° C. This demonstrates that a polyether polyol/polybutadiene polyol polyurethane block copolymer can be made according to the present technology from two dissimilar polyol compounds.

### Comparative Example 1

To the polyurethane prepolymer synthesized in Example 1, the appropriate amount of isophorone diamine, butyl acetate, and isopropanol were added to a reaction flask after which the reactor was sealed. The mixture was then allowed to react at 40° C. for 45 minutes followed by 80° C. for one hour to generate the final copolymer. The instant copolymer solution was then allowed to cool before final evaluation. The final copolymer solution had a viscosity of 1075 centipoise (cP) with a net volume solids of 35 percent. The final copolymer had the following properties: Tg=−80° C., Mn=15,125 g/mole, Mw=33,378 g/mole, PDI=2.21.

### Comparative Example 2—Polyurethane Random Co-Polymer

Following the synthetic procedure in Example 5 except that all three polyol samples were mixed together to yield a homogenous solution (polytetrahydrofuran (650 molecular weight), polypropylene glycol (2000 molecular weight), and polytetrahydrofuran (2000 molecular weight) prior to the reaction with the organic diisocyanate. The resulting random polyurethane prepolymer was then reacted with isophorone diamine in a manner similar to Example 5. The final copolymer solution had a net volume solids of 35.2 percent. The final copolymer had the following properties: Tg=−67° C., Mn=18,000 g/mole, Mw=33,000 g/mole, PDI=2.2.

### Comparative Example 3—Polyol Blend

Similar to Comparative Example 2, a polyol blend of polytetrahydrofuran (BASF, 2000 molecular weight, 41.4 grams, a polyether polyol), poly butadiene polyol (Kraton LBH 3000, 3000 molecular weight, 58.4 grams, hydroxyl-terminated polybutadiene), and butyl acetate (similar concentration as Example 2) were mixed together, however, the mixture gelled before the desired synthesis could be carried out. This demonstrates that a polyurethane random copolymer cannot be made from two dissimilar polyol compounds.

### Example 7—Lamination Bond Strength of Poly-co-Tetrahydrofuran-Block-co-Polyurethane Copolymers Incorporated into Ink Compositions

Adhesion to substrates by the polyurethane copolymer is typically accomplished through physical bonding but not chemically bonded. Aspects of the monomer choices can drastically impact the adhesion of the polyurethane copolymer to the substrate and the cohesion of the polyurethane copolymer with itself and with the pigment system used. Bonding and non-bonding forces can be used to increase the adhesion of the polyurethane copolymer. Exemplary bonding forces include ionic, covalent, and metallic. Exemplary non-bonding (intermolecular) forces include ion-dipole interactions, hydrogen-bonding, dipole-dipole interactions, ion-induced dipole interactions, dipole-induced dipole interactions, and dispersions.

Different polyurethane copolymer chemistries were evaluated in a lamination bond strength test which required the sample to be made into an ink and then used in a laminate. A laminate structure was constructed where two plastic substrates were joined using an adhesive with the printing encapsulated within the laminate. The bond strength was tested by pulling the laminated structure apart utilizing an Instron and recording the force required and noting any applicable observations.

Inks compositions were prepared from the instant polyurethane copolymers. To make an ink, a pigment was ground in the polyurethane copolymer under stress generated either by a bead mill such as a Lau Paint Shaker or a media mill such as an Eiger mill. A defoamer or adhesion promoter were added across all samples and should thus have equal impact across all samples. Finally, the dispersion was filtered and diluted to make the final ink in a targeted viscosity window.

The data below shows the lamination bond strength (grams force/inch) (“LBS”) with respect to the different samples and represents the lamination bond strength in grams force per linear inch. As can be seen from the data below, the instant polyurethane triblock copolymer showed improvement over a commercial polyurethane copolymer as described in Comparative Example 1 and the similar random polyurethane copolymer as described in Comparative Example 2.

| Sample | LBS |
|---|---|
| Comparative Example 1 | 210 |
| Comparative Example 2 | 220 |
| Example 5 | 280 |

### Example 8—Lamination Bond Strength of Poly-co-Tetrahydrofuran-Block-co-Polyurethane Copolymers Incorporated into Ink Compositions

Inks compositions were prepared following the same protocol as Example 7.

Lamination bond strengths of a 100% red ink and a red ink over a white ink were tested.

| Sample | LBS Red | LBS Red over White |
|---|---|---|
| Comparative Example 1 | 205 | 105 |
| Example 3 | 575 | 320 |
| Example 4 | 675 | 205 |

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1. A process for preparing a printed article, the process comprising:
applying an ink to a substrate; and
overlaying a substantially transparent lamination layer over the ink to envelope at least a portion of the substrate;
wherein the ink comprises a polyurethane copolymer-based binder, wherein the polyurethane copolymer comprises a block copolymer comprising the reaction product of a diisocyanate, a first polyol compound, a second polyol compound different from the first polyol compound, and a chain extending agent;
wherein:
the first polyol compound is a polyether polyol; and
the second polyol compound is selected from the group consisting of polyester polyols, polycarbonate polyols, polyether carbonate polyols, polybutadiene polyols, polycaprolactone polyols, polyether polyols, and combinations of two or more thereof;
with the proviso the polyurethane copolymer is essentially free of carboxylic groups or salts thereof.

2. The process of claim 1, wherein the polyurethane copolymer is prepared by a process comprising:
i) reacting the diisocyanate with the first polyol compound to produce a first polyurethane prepolymer comprising at least one isocyanate group;
ii) reacting the first polyurethane prepolymer of step i) with the second polyol compound to produce a second polyurethane prepolymer comprising at least one isocyanate group; and
iii) reacting the second polyurethane prepolymer of step ii) with a chain extending agent.

3. The process of claim 1, wherein the polyurethane copolymer has a weight average molecular weight of about 2,000 g/mol to about 100,000 g/mol.

4. The process of claim 1, wherein the ink comprises a solvent selected from the group consisting of methanol, ethanol, isopropanol, n-propanol, isobutanol, n-butanol, methyl acetate, ethyl acetate, isopropyl acetate, n-propyl acetate, n-butyl acetate, t-butyl acetate, isobutyl acetate, toluene, xylene, cyclohexane, n-hexane, cyclohexane, ethylene glycol monomethyl ether, ethylene glycol monoethyl ethers, ethylene glycol monobutyl ether, propylene glycol monomethyl ether, propylene glycol monoethyl ether, diethylene glycol monomethyl ether, diethylene glycol monobutyl ether and mixtures thereof.

5. The process of claim 1, wherein the diisocyanate is selected from the group consisting of 1,5-naphthylene diisocyanate, 4,4′-diphenylmethane diisocyanate, 4,4′-diphenyldimethylmethane diisocyanate, 4,4′-dibenzyl isocyanate, dialkyldiphenylmethane diisocyanate, tetraalkyldiphenylmethane diisocyanate, 1,3-phenylene diisocyanate, 1,4-phenylene diisocyanate, tolylene diisocyanate, butane-1,4-diisocyanate, hexamethylene diisocyanate, isopropylene diisocyanate, methylene diisocyanate, 2,2,4-trimethylhexamethylene diisocyanate, 2,4,4-trimethylhexamethylene diisocyanate, cyclohexane-1,4-diisocyanate, xylene diisocyanate, isophorone diisocyanate, lysine diisocyanate, dicyclohexylmethane-4,4′-diisocyanate, 1,3-bis(isocyanatomethyl)cyclohexane, methylcyclohexane diisocyanate, tetramethylxylene diisocyanate, and combination of two or more thereof.

6. The process of claim 1, wherein the chain extending agent is selected from the group consisting of ethylenediamine, propylenediamine, hexamethylenediamine, triethylenetetramine, diethylenetriamine, isophoronediamine, dicyclohexylmethane-4,4′-diamine, aminoethylethanolamine, and combinations of two or more thereof.

7. The process of claim 1, wherein the polyurethane copolymer exhibits a lamination bond strength of about 150 Win to about 700 Win.

8. The process of claim 1, wherein the polyurethane copolymer exhibits a lamination bond strength of about 150 Win to about 400 Win.

9. A process for preparing a retort packaging article, the process comprising: applying an ink to an inner surface of a substantially transparent lamination layer in a reverse printing orientation to form a printed laminate; and
applying the printed laminate to and enveloping at least a portion of a sealable packaging;
wherein the ink comprises a polyurethane copolymer-based binder, wherein the polyurethane copolymer comprises a block copolymer comprising the reaction product of a diisocyanate, a first polyol compound, a second polyol compound different from the first polyol compound, and a chain extending agent;
wherein:
the first polyol compound is a polyether polyol; and
the second polyol compound is selected from the group consisting of polyester polyols, polycarbonate polyols, polyether carbonate polyols, polybutadiene polyols, polycaprolactone polyols, polyether polyols, and combinations of two or more thereof;
with the proviso the polyurethane copolymer is essentially free of carboxylic groups or salts thereof.

10. The process of claim 9, wherein the polyurethane copolymer is prepared by a process comprising:
i) reacting the diisocyanate with the first polyol compound to produce a first polyurethane prepolymer comprising at least one isocyanate group;
ii) reacting the first polyurethane prepolymer of step i) with the second polyol compound to produce a second polyurethane prepolymer comprising at least one isocyanate group; and
iii) reacting the second polyurethane prepolymer of step ii) with a chain extending agent.

11. A printing ink composition comprising a solvent and a polyurethane copolymer-based binder, wherein the polyurethane copolymer comprises a block copolymer comprising the reaction product of a diisocyanate, a first polyol compound, a second polyol compound different from the first polyol compound, and a chain extending agent;
wherein:
the first polyol compound is a polyether polyol; and
the second polyol compound is selected from the group consisting of polyester polyols, polycarbonate polyols, polyether carbonate polyols, polybutadiene polyols, polycaprolactone polyols, polyether polyols, and combinations of two or more thereof;
with the proviso the polyurethane copolymer is essentially free of carboxylic groups or salts thereof.

12. The composition of claim 11, wherein the polyurethane copolymer is prepared by a process comprising:
i) reacting the diisocyanate with the first polyol compound to produce a first polyurethane prepolymer comprising at least one isocyanate group;
ii) reacting the first polyurethane prepolymer of step i) with the second polyol compound to produce a second polyurethane prepolymer comprising at least one isocyanate group; and
iii) reacting the second polyurethane prepolymer of step ii) with a chain extending agent.

13. A retort packaging article comprising:
a sealable foil-based packaging substrate having an inner and outer surface;
a laminate overlay having an inner face and an outer face, the inner face being proximal to the sealable foil-based packaging substrate; and
an indicia disposed between the sealable foil-based packaging substrate and the laminate overlay;
wherein:
the indicia comprises a polyurethane copolymer; and the retort packaging has been subjected to a temperature of 100° C. or greater for a time period sufficient to cure the ink; and
the polyurethane copolymer comprises a block copolymer comprising the reaction product of a diisocyanate, a first polyol compound, a second polyol compound different from the first polyol compound, and a chain extending agent;
wherein:
the first polyol compound is a polyether polyol; and
the second polyol compound is selected from the group consisting of polyester polyols, polycarbonate polyols, polyether carbonate polyols, polybutadiene polyols, polycaprolactone polyols, polyether polyols, and combinations of two or more thereof;
with the proviso the polyurethane copolymer is essentially free of carboxylic groups or salts thereof.

14. The article of claim 13, wherein the polyurethane copolymer is prepared by a process comprising:
i) reacting the diisocyanate with the first polyol compound to produce a first polyurethane prepolymer comprising at least one isocyanate group;
ii) reacting the first polyurethane prepolymer of step i) with the second polyol compound to produce a second polyurethane prepolymer comprising at least one isocyanate group; and
iii) reacting the second polyurethane prepolymer of step ii) with a chain extending agent.

15. A process for preparing a printed article, the process comprising:
applying an ink to a substrate; and
overlaying a substantially transparent lamination layer over the ink to envelope at least a portion of the substrate;
wherein the ink comprises a polyurethane copolymer-based binder, wherein the polyurethane copolymer comprises a block copolymer comprising the reaction product of a diisocyanate, a first polyol compound, a second polyol compound different from the first polyol compound, and a chain extending agent;
wherein:
the first polyol compound is selected from the group consisting of polyester polyols, polycarbonate polyols, polyether carbaonte polyols, polybutadiene polyols, polycaprolactone polyols, polyether polyols, and combinations of two or more thereof; and
the second polyol compound is selected from the group consisting of polyester polyols, polycarbonate polyols, polyether carbonate polyols, polybutadiene polyols, polycaprolactone polyols, polyether polyols, and combinations of two or more thereof;
with the proviso the polyurethane copolymer is essentially free of carboxylic groups or salts thereof.

16. The process of claim 15, wherein the polyurethane copolymer is prepared by a process comprising:
i) reacting the diisocyanate with the first polyol compound to produce a first polyurethane prepolymer comprising at least one isocyanate group,
ii) reacting the diisocyanate with the second polyol compound to produce a second polyurethane prepolymer comprising at least one isocyanate group,
iii) reacting the first polyurethane prepolymer of step i) with the chain extending agent to produce a third polyurethane prepolymer comprising at last one amino group; and
iv) reacting the third polyurethane prepolymer of step iii) with the second polyurethane prepolymer of step ii).

17. The process of claim 15, wherein the polyurethane copolymer has a weight average molecular weight of about 2,000 g/mol to about 100,000 g/mol.

18. The method of claim 15, wherein the polyurethane copolymer exhibits a lamination bond strength of about 150 Win to about 700 Win.

19. The method of claim 15, wherein the polyurethane copolymer exhibits a lamination bond strength of about 150 Win to about 400 Win.

20. A printing ink composition comprising a solvent and a polyurethane copolymer-based binder, wherein the polyurethane copolymer comprises a block copolymer comprising the reaction product of a diisocyanate, a first polyol compound, a second polyol compound different from the first polyol compound, and a chain extending agent;
wherein:
the first polyol compound is selected from the group consisting of polyester polyols, polycarbonate polyols, polyether carbaonte polyols, polybutadiene polyols, polycaprolactone polyols, polyether polyols, and combinations of two or more thereof; and
the second polyol compound is selected from the group consisting of polyester polyols, polycarbonate polyols, polyether carbonate polyols, polybutadiene polyols, polycaprolactone polyols, polyether polyols, and combinations of two or more thereof;
with the proviso the polyurethane copolymer is essentially free of carboxylic groups or salts thereof.

21. The composition of claim 20, wherein the polyurethane copolymer is prepared by a process comprising:
i) reacting the diisocyanate with the first polyol compound to produce a first polyurethane prepolymer comprising at least one isocyanate group,
ii) reacting the diisocyanate with the second polyol compound to produce a second polyurethane prepolymer comprising at least one isocyanate group,
iii) reacting the first polyurethane prepolymer of step i) with the chain extending agent to produce a third polyurethane prepolymer comprising at last one amino group; and
iv) reacting the third polyurethane prepolymer of step iii) with the second polyurethane prepolymer of step ii).
